(19) United States
(12) Patent Application Publication
(10) Pub. No.: US 2009/0222506 A1
(43) Pub. Date: Sep. 3, 2009

(54) System and method for metering and analyzing usage and performance data of a virtualized compute and network infrastructure

(75) Inventors: Donald C. Jeffery, Matawan, NJ (US); John M. Clark, Little Silver, NJ (US); Scott T. Frenkiel, Freehold, NJ (US); Ching-Cheng Chen, Middletwon, NJ (US); Ivan C. Ho, Middletown, NJ (US)

Correspondence Address: GEARHART LAW, LLC, 4 FERNDALE ROAD, CHATHAM, NJ, 07928, US

(73) Assignee: EVIDENT SOFTWARE, INC., NEWARK, NJ (US)

(21) Appl. No.: 12/321,282

(22) Filed: Jan. 20, 2009

Related U.S. Application Data
(60) Provisional application No. 61/067,626, filed on Feb. 29, 2008.

(51) Int. Cl. G06F 15/16

(52) U.S. Cl. 709/202; 709/201

(57) ABSTRACT

A method and system for metering and analyzing usage and performance data of virtualized compute and network infrastructures is disclosed. The processing functions of the metered data are divided into “processing units” that are configured to execute on a server (or plurality of interconnected servers). Each processing unit receives input from an upstream processing unit, and processes the metered data to produce output for a downstream processing unit. The types of processing units, as well as the order of the processing units is user-configurable (e.g. via XML file), thus eliminating the need to modify source code of the data processing application itself, thereby saving considerable time, money, and development resources required to manage the virtualized compute and network infrastructure.

### CLAIM OF PRIORITY

This application claims priority to U.S. Ser. No. 61/067,626 filed Feb. 29, 2008, the contents of which are fully incorporated herein by reference.

### FIELD OF THE INVENTION

The present invention relates to IT service management, and more particularly, to a system and method for the metering and analyzing of usage and performance data associated with enterprise IT infrastructures having highly virtualized compute and data networks.

### BACKGROUND OF THE INVENTION

With deployment of new virtualized Service-Delivery Models, IT projects will be hampered by the lack of capabilities in their current enterprise management tools to manage heterogeneous virtual machine, virtual application and grid utility computing environments. Traditional tools work well in a dedicated, monolithic infrastructure where the model is one-to-one. However, when the legacy model shifts to one-to-many (single instance, multi-tenant) architecture, today's tools lack the ability to connect the resource with users and service being delivered within the utility computing infrastructure. The emergence of technologies like server and storage virtualization, compute and data grids (real time infrastructure), web services, Service Oriented Architecture (SOA) and Software as a Service (SaaS), will require new tools to provide transparency into application consumption of these virtual resources. Furthermore, the Service-Delivery Model requires relating the virtual-resource demand and consumption to the business processes that it serves.

A large component of the Service-Delivery Model is the compute and data grids where computing resources and data caches are virtualized and delivered to an application, on-demand. A compute grid is a computing model that distributes application processing across a parallel physical infrastructure and throughput is increased by networking many heterogeneous physical compute resources across administrative boundaries to create a virtual computer architecture. A data grid is the controlled sharing and management of large amount of distributed data such as in a clustered application environment. Often, data grids are combined with compute grids to support a virtualized services/application environment.

The adoption of a real-time enterprise (RTE) results in challenges for IT and its customers. IT services are no longer limited to keeping the “lights on.” A utility-oriented service delivery model requires IT to provide performance reporting to the end-users of each set of applications and in some cases even have contracted Service Level Agreements (SLA) with business unit customers. With the adoption of RTE, it becomes difficult to know whether an application's components are properly functioning across the virtualized infrastructure, and today's tools are ill equipped to meet this pressing service management need.

Processing statistics about resource usage and performance in a large computer network can be very complex. Factors such as the underlying physical architecture, as well as the nature of the applications being run, can impact the methods used to process this data. These parameters can vary widely amongst deployed computer networks. Therefore, what is desired is an improved processing system and method, that facilitates efficient customization, enabling the system to adapt to new architectures and applications.

### SUMMARY OF THE INVENTION

The present invention provides a configurable IT resource statistics processing system and method. The processing is divided into “processing units” that are configured to execute on a server (or plurality of interconnected servers). For the purposes of this disclosure, this server will be referred to as the “pipeline server.” It will be understood that the pipeline server may be implemented via a single server machine, or a plurality of interconnected servers, without departing from the scope of the present invention.

Each “processing unit” (also referred to as a “pipeline component”) receives input from an upstream processing unit (or data collection system, in the case of the first processing unit), and processes the input according to its specific function(s), and produces output for a downstream processing unit (or data warehouse, in the case of the final processing unit). The types of processing units, as well as the order of the processing units is user-configurable (e.g. via XML file), thereby eliminating the need to modify source code of the data processing application itself when the implementation of additional business logic is required. This saves considerable time, money, and development resources over the systems of the prior art.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting.

Certain elements in some of the figures may be omitted, or illustrated not-to-scale, for illustrative clarity. Block diagrams may not illustrate certain connections that are not critical to the implementation or operation of the present invention, for illustrative clarity.

FIG. 1 shows a block diagram of an exemplary system in which the present invention is used.

FIG. 2 shows a block diagram illustrating components of the pipeline server of the present invention.

FIG. 3 shows a block diagram representation of an exemplary configuration of a pipeline server.

FIG. 4 shows a flowchart indicating process steps to perform the method of the present invention.

FIG. 5 shows a block diagram of an additional exemplary configuration of a pipeline in accordance with the present invention.

### DESCRIPTION OF THE PREFERRED EMBODIMENTS

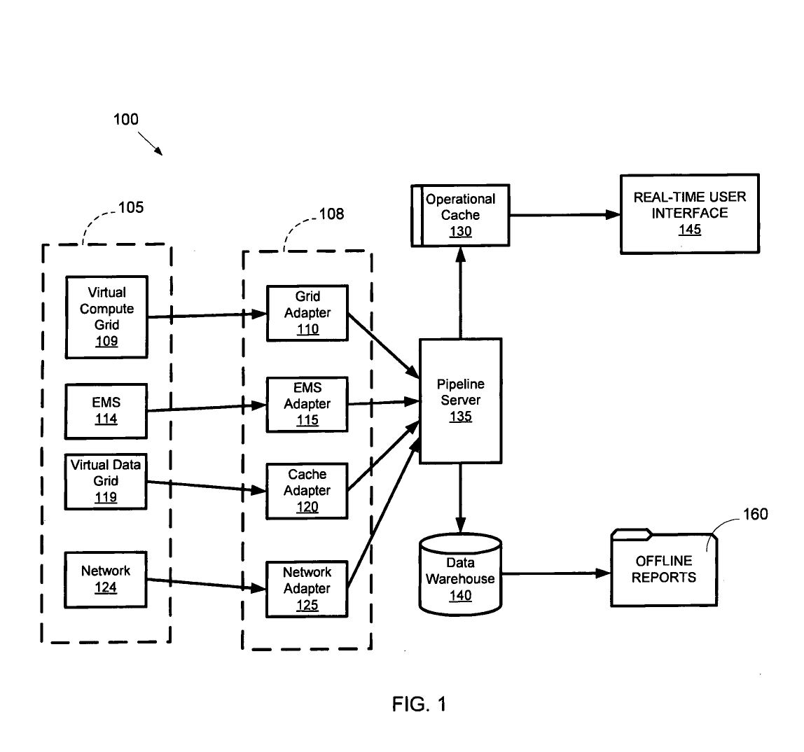

FIG. 1 shows a block diagram of an exemplary system 100 in which the present invention is used. System 105 is an enterprise IT system, providing an infrastructure that provides compute, storage, and network services to service one or more virtualized applications. System 105 comprises a virtual compute grid 109 for high volume compute tasks, an EMS (Enterprise Management System) 114 for measuring various performance metrics, such as CPU utilization, memory utilization, and network throughput, to name a few. System 105 also comprises virtual data grid 119 for scalable high-speed data access across a resilient network, and network 124, which comprises the communication paths among the various entities in system 105.

Data collection system 108 comprises one or more collection adapters. Each collection adapter is a software component that collects performance and usage statistics for the components identified in system 105. The adapters in system 108 convert that raw usage and performance data into a normalized, common format, hereinafter referred to as a Universal Data Record (UDR).

In FIG. 1, four collection adapters are shown. However, there may be more or fewer adapters, as dictated by the desired infrastructure monitoring requirements. Grid Adapter 110 collects workload activity and performance data from virtual compute grid 109. The compute grid 109 allocates compute resources (CPU execution cycles) to the virtualized distributed applications running in the realm of system 105. Information collected by the grid adapter 110 may include, but is not limited to, information about service requests, workload activity, computing performance data, information about tasks, grid node performance, and grid server broker performance, and grid infrastructure statistics. One such compute grid vendor that may be used is the DataSynapse™ GridServer®, produced by DataSynapse Inc., of New York, N.Y.

The EMS (Enterprise Management System) adapter 115 collects system level performance metrics from EMS 114. Parameters measured may include, but are not limited to, CPU utilization, memory utilization, free memory, total memory, network packets in, network packets out, network bytes in, network bytes out, network collisions, network errors, storage utilization, free storage space, and total storage available. The EMS adapter 115 may be configured to operate with a variety of enterprise management systems or system resource monitors. One such performance monitor is BMC® Performance Assurance®, produced by BMC Software, of Houston, Tex.

The Cache adapter 120 is responsible for collecting usage and performance information from virtual data grid 119 to obtain caching performance metrics and storage node utilization. Such information include cache memory utilization, data object update and access performance, client access performance, hit/miss performance, and cache network utilization. The Cache adapter 120 may be configured to operate with a variety of cache reporting systems. One such system is Oracle® Coherence, produced by Oracle Corporation, of Redwood Shores, Calif.

The Network adapter 125 collects local or wide area Internet Protocol (IP) network performance and usage data from network 124. The information includes IP-to-IP network conversations with application layer protocol such as IP ports and protocols used, bandwidth consumption, and other traffic information received from IP network routers and switches. A key source of such network information originates from Cisco Systems, Inc. of San Jose, Calif. networking hardware with Netflow exports.

As mentioned previously, each adapter converts the raw information it receives from the various sources into UDR files, providing data in a consistent, normalized format to the pipeline server 135. The pipeline server, which will be explained in more detail in the upcoming paragraphs, processes the data from the data collection system 108. The raw data processed and analyzed by the pipeline server 135 is transformed and enriched for output to the data warehouse 140, where the data is stored, and can then be used to generate a variety of offline reports 160, such as reports comparing actual performance with that specified in a Service Level Agreement (SLA), grid performance, and resource usage, to name a few. Additionally, enriched data from pipeline server 135 may also be fed to an operational cache 130, where the data is stored in a system to facilitate fast retrieval, for the support of real-time user interface 145.

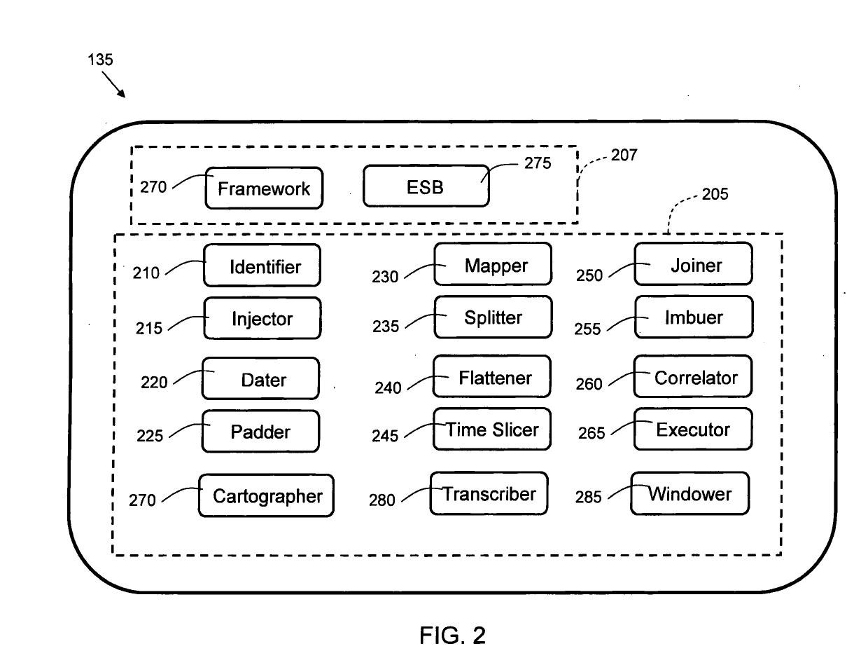

FIG. 2 shows a block diagram illustrating components of the pipeline server 135 of the present invention. The pipeline server 135 comprises a plurality of processing components 205, and a plurality of support components 207. The support components 207 facilitate the execution sequence of the pipeline components 205, and interaction with the other parts of the overall system described in the explanation of FIG. 1.

### Pipeline Components

Each pipeline component receives input from an upstream source (another pipeline component or data collection system), processes the input, and produces output for a downstream pipeline component or other consumer of the data. The pipeline's logic, is defined in pipeline definition files. A pipeline definition file describes the flow and logic between component interfaces and data exchanges. All the business and application logic is “external,” in that it is stored outside of the compiled binary code that comprises pipeline server 135. In one embodiment, the pipeline definition files are stored in an XML format. This architecture minimizes the need to modify source code of the pipeline server 135. The present invention provides a system that is highly componentized and agile in meeting a variety of different customer requirements.

The functionality of each pipeline component will now be explained. However, the following list of pipeline components is not exhaustive. Additional pipeline components are contemplated, and within the scope of the present invention.

The Identifier 210 is used to provide a unique identifier to each incoming UDR. In one embodiment, the Identifier 210 adds a unique 64 bit long value to serve as the identifier. This provides an attribute of a local enrichment to the UDR.

The Injector 215 is used to take values associated with named property keys arriving in a message-associated properties map then injecting these as enrichment attributes as part of a topical enrichment. This facilitates classification of the UDRs in various ways. For example, a default name identifier can be added to each UDR, based on the named property keys contained therein.

The Dater 220 is used to synchronize the time of each UDR. The incoming data from the various sources can have a variety of time formats and locale data. The Dater 220 converts timestamp values associated with the incoming UDR and formats them according to a predetermined time format (e.g. GPS time, UTC time, etc . . . ). This facilitates efficient production of formatted dates for end-user reporting.

The Padder 225 is used to introduce “pad” elements to the UDR as enrichments based on an identified topic (default pad). A map of attribute key-value pairs is supplied. Each of these is added as part of enrichment to every processed UDR as it passes through this component.

The Mapper 230 is used to apply further categorization to an incoming UDR. For example, Mapper 230 can be used to map each UDR to the grid application or service associated with the attributes specified in the UDR, adding a new attribute representing the correlation of the usage or performance to the application in the outgoing UDR.

The Splitter 235 is used to extend the UDR by evaluating predetermined criteria regarding one or more attributes contained within the incoming UDR. In one embodiment, a regular expression is applied against the value of the attribute(s) within the UDR. The result of the evaluation is introduced as new attributes into the outgoing UDR.

The Flattener 240 is conventionally used to take a substantively enriched (processed) measurement that has been enriched in a topical hierarchical fashion (an original UDR plus its “child” topical UDRs) and compose a resultant UDR that incorporates selected topical enrichments from child UDRs while removing (flattening) the hierarchy of the original enriched UDR. This facilitates output in accordance with relational database table conventions.

The Time Slicer 245 is used to create multiple outgoing UDRs based on a single incoming UDR by taking data from a specified time range within the incoming UDR, and assembling a new outgoing UDR for each specified range. For example, a UDR may contain performance data over a wider time interval (say 12 hours), and the Time Slicer 245 can generate 12 outgoing UDRs, each containing data over a one-hour interval. An example of this might be a long running grid compute task that runs over many hours or even days and break the single UDR that represents the task down to specific hourly intervals each with its own task UDR. This is typically used to break long-term UDRs into ones that fit across a time boundary (e.g. hourly intervals).

The Joiner 250 pipeline component composes a new UDR for each combination of this UDR with any extension in the named topicSet, if any, or all extensions. A Joiner can be used when processing long running tasks (e.g. in a compute grid), it is desirable to take a single measure (UDR) of task consumption and create multiple measures (UDRs) of task consumption for each day that a long-running task is executing. For example, a task that starts on Saturday and finishes on Monday morning arrives as a single measurement but is processed by a Joiner into 3 measurements, one for each day. The joiner is used to compose (non-time-specific) attributes of the original measurement with the time specifics of each day. The result of joining in this case yields 3 measurements, or 3 UDRs, from the original UDR.

The Imbuer 255 is a form of mapper that works directly with one or more containers to perform multiple mappings. It typically used to mix in detailed attributes that are keyed to data that is stored in a configuration asset database. It establishes relationships between data in a UDR file and asset details that are stored in a configuration DB that can be maintained throughout a pipeline without carrying the data as part of the UDR.

The Correlator 260 component provides a means for correlating messages. The incoming UDRs are analyzed to determine if a pattern or trend exists. The patterns may include those for network and application monitoring, finance, or scheduling. There are various commercially available correlation engines that may be used to facilitate implementation of the Correlator 260 component. One such correlation engine is Esper Stream and Complex Event Processing, by EsperTech Inc., of Wayne, N.J.

The Executor 265 provides a facility to use external processes as part of a pipeline. For example, the Executor 265 may invoke the BCP (Bulk Copy Program) of a database to export information to a reporting portal. In this case, the BCP program is an external program (or a remote procedure) that can be executed from within a pipeline process using the Executor pipeline component. The external program could be passed a pointer to relevant data, which it has to process and it could return data that could potentially be used by the next component in the pipeline.

The Cartographer 270, as its name implies, is a maker of maps. Typically a cartographer is used to dynamically assemble a mapping relationship that is subsequently used by a Mapper to perform a mapping function. For example, a cartographer can be used to establish the mapping of compute grid jobs to applications (i.e. a mapping from a JOB_ID to APP_ID) by building and maintaining such a map as jobs are mapped to applications that are responsible for spawning those jobs on the grid. Later, when a task is processed, should no explicit task to application mapping exist, a mapping can be inferred using the task's parent (i.e. its JOB).

The Transcriber 280 transcribes, or copies, each identified source attribute to one (or more) destination attributes. This provides the ability to use different attribute names for the same attribute in different components in the pipeline.

A Windower 285 temporally organizes information from a UDR. The windower 285 fits (or bucketizes) consumption based on an available date/time of consumption (i.e. from a UDR attribute) to a normalized interval. In one embodiment, a normalized interval is provisioned as one of the following types (HOURLY, DAILY, WEEKLY, MONTHLY, QUARTERLY, SEMIANNUALLY, ANNUALLY). The process of windowing enriches the UDR to establish the date/time boundaries (start and end) of the normalized interval that the consumption falls into. For example, a consumption said to be occurring at Jan. 4, 2008 at 4:05 PM would be enriched to identify an HOURLY interval of Jan. 4, 2008 4:00 PM-Jan. 4, 2008 5:PM or a DAILY interval of Jan, 4, 2008 0:00-Jan. 5, 2008 0:00 or a MONTHLY interval of Jan. 1, 2008 0:00-Feb. 1, 2008 0:00 etc.

A UDRFanOutWriter 290, is typically used during a “rating process” used to assign costs to metrics being measured by the system (e.g. CPU time). The UDRFanOutWriter is essentially a UDR distribution mechanism that routes UDRs to different (pre-rated) UDR files based on attributes contained within the UDRs. This is a generic mechanism; but can be provisioned to perform UDR distribution based on start time (hourly granularity), grid name and collection batch. This facilitates the selection of an appropriate UDR set at the time a rating interval is chosen.

### Support Components

The Framework 270 is used to facilitate the execution sequence of the various pipeline components 205. Each execution sequence is referred to as a “pipeline,” and the pipeline server 135 can have multiple pipelines defined and running simultaneously. Each pipeline comprises multiple pipeline components with different compositions to achieve the desired functionality required by the business logic. The framework 270 provides the means to establish pipelines, determine which pipeline components are contained in the pipelines, and enforce the pipeline flow during execution time. In one embodiment, the framework is the Spring Framework used in conjunction with J2EE (Java™ 2 Platform Enterprise Edition). Spring is an open source framework for building POJO's (Plain Old Java Objects) and J2EE is a platform-independent, Java-centric environment from Sun Microsystems, Inc. of Santa Clara, Calif. It is used for developing, building and deploying Web-based enterprise applications. The J2EE platform consists of a set of services, APIs, and protocols that provide the functionality for developing applications. When the Spring Framework is used as the framework 270, the pipeline components 205 are preferably implemented as “Plain Old Java Objects” (POJOs). The pipeline definition files store the pipeline configurations, which includes the pipeline components that belong to each pipeline, and the order in which they are executed using specific UDR files.

The Enterprise Service Bus (ESB) 275 is used to support asynchronous and synchronous event processing, as well as messaging brokering for communications between the POJOs (pipeline components) that comprise the various pipeline components 205. The ESB 275 defines stops or “endpoints” through which applications can send or receive data to or from different pipeline components of the system. The ESB 275 comprises a messaging bus, which is responsible for routing messages between endpoints. The endpoints could be on the same physical system and application or on different systems and across different applications connected via an enterprise network. In one embodiment, the ESB 275 is the Mule Enterprise Service Bus integration platform. Mule is an Open Source project maintained by MuleSource of San Francisco, Calif., and is based on a Staged Event Driven Architecture (SEDA), which provides robustness and scalability, and it manages all components services such as pooling, threading, management, and security.

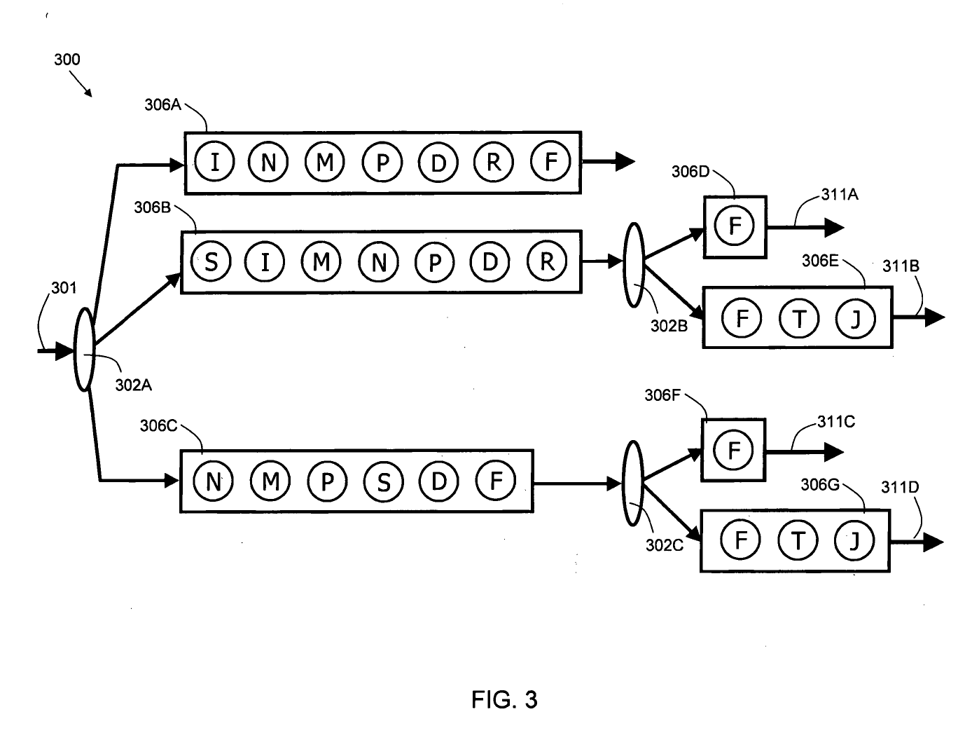

FIG. 3 shows a block diagram representation of an exemplary configuration 300 of a pipeline server. There are 7 pipelines shown in FIG. 3, indicated as references 306A-306G. Each pipeline has at least one pipeline component therein. The following symbols are used in FIG. 3 to represent the various pipeline components:

| Symbol | Component Name |
|---|---|
| I | Identifier |
| N | Injector |
| M | Mapper |
| P | Padder |
| D | Dater |
| F | Flattener |
| S | Splitter |
| T | Time Slicer |
| J | Joiner |
| C | Correlator |
| E | Executor |
| A | Cartoghapher |
| B | Imbuer |
| Tr | Transcriber |
| W | Windower |

For example, pipeline 306A contains the following execution order of pipeline components:
1) Identifier
2) Injector
3) Mapper
4) Padder
5) Dater
6) Processor
7) Flattener

In the exemplary embodiment of FIG. 3, there is a routing component 302A in the pipeline server responsible for taking UDR input files from the adapters 301. The pipeline server's router component 302A decides on which pipeline to invoke for processing each set of UDRs. The router component examines the UDR metadata and its contents (parameters) to make a decision on which pipeline to choose for processing of a specific set of UDR files. The input of routing module 302A, indicated as 301, is the input to the pipeline server 135. The UDRs coming in to input 301 may be disparate, normalized, or enriched. Additional enrichment processing occurs at the various components within a pipeline. For example, the enrichment may be local enrichment, such as adding a unique identifier, or topical enrichment, such as adding application or resource usage attributes to the UDR.

Routing module 302A determines which pipeline (306A, 306B, or 306C) receives a specific set of UDRs. The decision of which pipeline to activate for a specific UDR depends on how the pipelines are configured, information contained in the UDR files itself, and the end reporting and analytics requirements.

Once a routing module has made a decision, the UDR is then sequentially processed by each component in a given pipeline (302A-302G). Each component of the pipeline performs a specific function or operation on the data contained within the UDR. In one embodiment of the present invention, the order of each component and the structure of a specific pipeline are configured via XML configuration files. Exit points 311A-311D represent the exit points from the pipeline server. Data leaving the exit points 311A-311D will be sent to the operational cache (130 of FIG. 1) and/or data warehouse (140 of FIG. 1). As is evident in FIG. 3, the output of pipelines may feed routing modules, which may in turn feed other pipelines. This is the case with pipeline 306B, the output of which feeds routing module 302B which, in turn, routes the UDRs to either pipeline 306D or pipeline 306E, as appropriate.

Note that there are many possible permutations of pipelines and pipeline components. Each pipeline may be assigned a given UDR for processing based on different criteria. For example, pipeline 306A can be used for processing UDRs from compute grid workloads (batch jobs), while pipelines 306B and 306C can be used for processing UDRs from two different interactive applications. Pipelines 306D and 306E further process the output of pipeline 306B. The pipeline 306D processes the input through a flattener (F), and then outputs the data out of the pipeline server. Pipeline 306E processes the input UDRs through a flattener (F), a time slicer (T), and a joiner (J), after which, the UDRs exit the pipeline server. Pipeline 306E is configured for temporal categorization of data, hence the use of a time slicer (T) pipeline component.

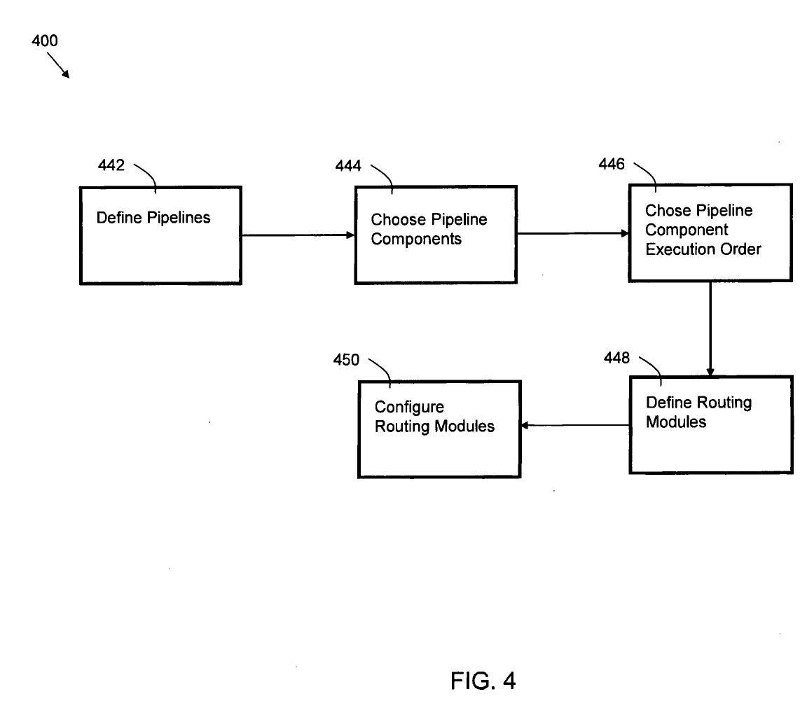

FIG. 4 shows a flowchart 400 indicating process steps to perform the method of the present invention. The pipeline definitions define the business logic that is to be implemented to process the data being collected by the data collection system 108 of FIG. 1. In process step 442, the pipelines are defined. In process step 444, the set of pipeline components is selected for each pipeline based on the business logic to be implemented. In process step 446, the execution order of the pipeline components within each pipeline is established. In process step 448, routing modules are defined. These are used to distribute UDRs to different pipelines within the pipeline server. In process step 450, the routing modules are configured. This involves establishing the criteria used to determine which UDRs get sent to which pipelines. The aforementioned process steps are preferably performed via software comprising a graphical user interface. The settings information (e.g. pipeline information, routing module information, etc . . . ) is then stored in non-volatile storage. In a preferred embodiment, one or more XML files are used to store the settings.

As can now be appreciated, the present invention provides an externally configurable pipeline server that is can be adapted to a variety of infrastructure source data without the need to modify source code of the pipeline server itself. In a preferred embodiment, the invention can be supplemented with an advanced user interface to construct the pipeline definitions to simplify the pipeline construction processes 400. The ability to use simple configuration to implement new business logic saves considerable time, money, and development resources required for building additional features to support new instrumentation or data feeds from dynamic and rowing enterprise IT infrastructures.

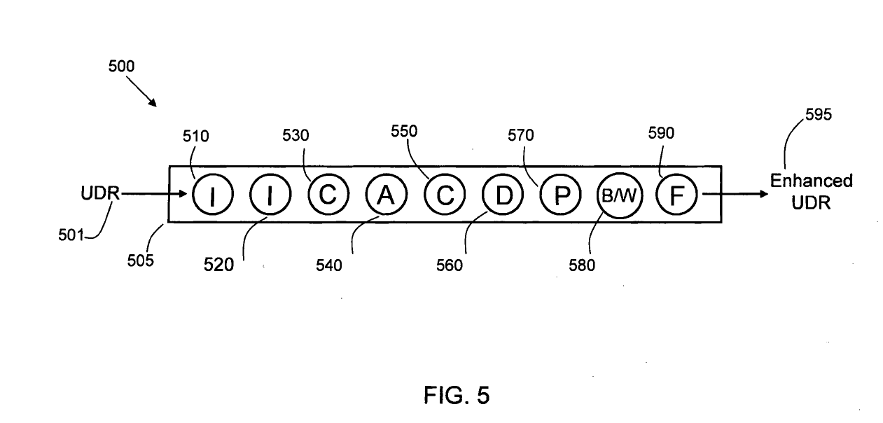

FIG. 5 shows a block diagram of an additional exemplary configuration of a pipeline 500 in accordance with the present invention. Pipeline 500 is an exemplary pipeline illustrating a use case that process JOB records within a compute grid environment. A JOB is a submission of work to a compute grid that is broken down into individual tasks that are run in parallel across the available compute resources of the grid.

The JOB pipeline 500 accepts as input, a JOB UDR file 501 that contains the collected metrics obtained from the grid compute system. The following table illustrates the types of information (attributes) that may be included in this type of UDR record (note that this is an exemplary record, and it is possible to have a JOB UDR with different fields and still be within the scope of the present invention):

Original UDR

| UDR Value | UDR Field |
|---|---|
| APP1 | APP Name |
| 1528.2 | AVG_TASK_DUR |
| 1 | BROKER |
| Dept | DEPT_NAME |
| Desc | DESCRIPTION |
| 5 | END_PRIORITY |
| 1195103360350 | END_TIME |
| 4 | ENGINE_COUNT |
| DB Server Test | GRID |
| group | GROUP_NAME |
| 107130646457 | ID |
| indiv | INDIV_NAME |
| job class | JOB_CLASS(string) |
| 107130646457 | NAME(string) |
| 5 | PRIORITY(int) |
| user | REQUESTOR |
| host | REQUEST_HOST |
| service type | SERVICE_TYPE |
| 1195103358607 | START_TIME |
| 2 | STATUS |
| 5 | TASK_COUNT( |
| 0 | TASK_TIME_AVG |
| 0 | TASK_TIME_STD |
| 7641 | TOTAL_TASK_DURATION |

In Stage #1 and Stage #2 two Identifier pipeline components 510 and 520, are used back-to-back to create a “child” UDR (a child UDR is a UDR that contains information based on, or derived from, the JOB UDR 501) that contains a globally unique RECORD_ID value associated with the original UDR and a BATCH_ID associated with the grid JOB workload contained in the original UDR. The child UDR is attached (or associated with) the original UDR and contains the enriched information created by the Identifier pipeline component. The XML definition of this portion of the pipeline (Stage #1 and Stage #2) can be expressed as follows:

```
<!-- JOB STAGE 1 - add unique ID (RECORD_ID) to ids extension -->
    <mule-descriptor name=“jobAddUniqueRecordID” implementation=“adapter.grid.ids.record_id”>
        <inbound-router>
            <endpoint address=“vm://job_stage_1.queue”/>
        </inbound-router>
        <outbound-router>
            <router className=“org.mule.routing.outbound.OutboundPassThroughRouter”>
                <endpoint address=“vm://job_stage_2.queue”/>
            </router>
        </outbound-router>
    </mule-descriptor>
<!-- JOB STAGE 2 - mix in BATCH_ID to ids extension -->
    <mule-descriptor name=“jobAddBatchID”_implementation=“adapter.grid.ids.batch_id”>
        <inbound-router>
            <endpoint address=“vm://job_stage_2.queue”/>
        </inbound-router>
        <outbound-router>
            <router className=“org.mule.routing.outbound.OutboundPassThroughRouter”>
                <endpoint address=“vm://job_stage_3.queue”/>
            </router>
        </outbound-router>
    </mule-descriptor>
```

The resulting child UDR on topic ID is illustrated in the following table:

Child UDR: Topic IDs

| UDR Value | UDR Field |
|---|---|
| 80027219450273 | RECORD_ID |
| 80027219450274 | BATCH_ID |

In Stage #3, the Correlator 530 is used to add a new attribute named “APPLICATION_ID” to the child UDR. This attribute is based on the application of template-generated mapping rules to resolve the ID of the usage-associated application from the system “assets db”. This result is used later in pipeline processing to associate the JOB defined in the original UDR to an application that submitted the JOB to the grid for processing. The XML description and resulting child UDR for this stage of the example pipeline is as follows:

```
<!-- JOB STAGE 3 - mix in APPLICATION_ID (based on resolver)
to ids extension -->
    <mule-descriptor name=“jobAddApplicationID”
    implementation=“adapter.grid.mapper.application_id.job”>
        <inbound-router>
            <endpoint address=“vm://job_stage_3.queue”/>
        </inbound-router>
        <outbound-router>
            <router className=“org.mule.routing.outbound.
            OutboundPassThroughRouter”>
                <endpoint address=“vm://job_stage_4.queue”/>
            </router>
        </outbound-router>
    </mule-descriptor>
```

Child UDR: Topic IDs

| UDR Value | UDR Field |
|---|---|
| 80027219450273 | RECORD_ID |
| 1486 | APPLICATION_ID |
| 80027219450274 | BATCH_ID |

Stage #4 uses a Cartographer pipeline component 540, to create/update a map of JOBs to APPLICATION mapping ID attribute to resolved APPLICATION_ID. This would later be used to perform mapping from TASKs to APPLICATION in the event there were no task-specific application mapping rules (using JOB to APPLICATION mapping). This allows the system to specify fewer app mapping rules taking advantage of the fact that a TASK identifies its parent JOB (inheritance). No child UDR extension is created at this step. The XML definition for this stage is as follows:

```
<!-- JOB STAGE 4 - store APPLICATION_ID by job for later
use in mapping tasks -->
    <mule-descriptor name=“jobStoreApplicationID”
    implementation=“adapter.grid.cartographer.application_id.job”>
        <inbound-router>
            <endpoint address=“vm://job_stage_4.queue”/>
        </inbound-router>
        <outbound-router>
            <router className=“org.mule.routing.outbound.
            OutboundPassThroughRouter”>
                <endpoint address=“vm://job_stage_5.queue”/>
            </router>
        </outbound-router>
    </mule-descriptor>
```

In Step #5, another Correlator 530 is used via a pipeline component wrapper to add another child UDR on topic “SLA”. This child UDR has one new attribute named “SLA_VIOLATION_COUNT” that is based on the application of template-generated SLA compliance rules to resolve how many SLA violations have occurred in accordance with SLAs established for the parent application. A Service Level Agreement (SLA) is a definition of a minimum application/service level performance metric that was defined when the application was boarded (configured) into the system. If the grid cannot deliver the performance level defined by the agreed-to metric, the system then defines an exception and it is added to the child UDR created by this stage of the pipeline. The XML and resulting child UDR for this stage is as follows:

```
<!-- JOB STAGE 5 - mix in SLA_VIOLATION_COUNT (based
on SLA handler) to sla extension -->
    <mule-descriptor name=“jobAddSLA”
    implementation=“adapter.grid.sla.job”>
        <inbound-router>
            <endpoint address=“vm://job_stage_5.queue”/>
        </inbound-router>
        <outbound-router>
            <router className=“org.mule.routing.outbound.
            OutboundPassThroughRouter”>
                <endpoint address=“vm://job_stage_6.queue”/>
            </router>
        </outbound-router>
    </mule-descriptor>
```

Child UDR: Topic SLA extension

| UDR Value | UDR Field |
|---|---|
| 35 | SLA_VIOLATION_COUNT |

Stage #6 uses a Dater pipeline component 560, to add a child UDR on topic “dates”. This child UDR has two new attributes (START_DATETIME and END_DATETIME) that are based on the conversion of epoch-based long integer timestamps (see START_TIME and END_TIME in the original UDR) to a format that can be used by standard relational databases (i.e. SQL date/time compatible strings). The XML description and resulting child UDR are as follows:

```
<!-- JOB STAGE 6 - SQLDATETIME compatible date enrichment
for start / end times -->
    <mule-descriptor name=“jobEnrichDates”
    implementation=“adapter.grid.dates”>
        <inbound-router>
            <endpoint address=“vm://job_stage_6.queue”/>
        </inbound-router>
        <outbound-router>
            <router className=“org.mule.routing.outbound.
            OutboundPassThroughRouter”>
                <endpoint address=“vm://job_stage_7.queue”/>
            </router>
        </outbound-router>
    </mule-descriptor>
```

Child UDR: Topic dates extension

| UDR Value | UDR Field |
|---|---|
| 2007-11-15 00:09:18.607 | START_DATETIME |
| 2007-11-15 00:09:20.350 | END_DATETIME |

Stage #7 uses a Padder pipeline component 570, to add a child UDR on topic “pad”. This child UDR has two new attributes (VIEWABLE and RUN_KEY) with default values statically derived from the system configuration. The VIEWABLE attribute is used by the reporting system to indicate that the data in the UDR is the most current and the RUN_KEY is used to group a set of events into a workload. The XML and resulting child UDR for this stage are as follows:

```
<!-- JOB STAGE 7 - add pad fields -->
    <mule-descriptor name=“jobPad”
    implementation=“adapter.grid.pad.job”>
        <inbound-router>
            <endpoint address=“vm://job_stage_7.queue”/>
        </inbound-router>
        <outbound-router>
            <router className=“org.mule.routing.outbound.
            OutboundPassThroughRouter”>
                <endpoint address=“vm://job_stage_8.queue”/>
            </router>
        </outbound-router>
    </mule-descriptor>
```

Child UDR: Topic pad extension

| UDR Value | UDR Field |
|---|---|
| Y | VIEWABLE |
| 0 | RUN_KEY |

Stage #8 uses a combined Imbuer and Windower pipeline component 580, to add a child UDR on topic “workload”. This child UDR has one new attribute (RUN_ID) that contains a normalized interval whose interval type, e.g. daily, hourly etc. is given by resolving the workload cutoff detail associated with this JOB's resolved application. The RUN_ID, contains the interval-adjusted value of the JOB's START_TIME. The XML and resulting child UDR are as follows:

```
<!-- JOB STAGE 8 - workload -->
    <mule-descriptor name=“jobWorkload”
    implementation=“adapter.grid.workload.job”>
        <inbound-router>
            <endpoint address=“vm://job_stage_8.queue”/>
        </inbound-router>
        <outbound-router>
            <router className=“org.mule.routing.outbound.
            OutboundPassThroughRouter”>
                <endpoint address=“vm://job_stage_9.queue”/>
            </router>
        </outbound-router>
    </mule-descriptor>
```

Child UDR: Topic workload extension

| UDR Value | UDR Field |
|---|---|
| 1723920472 | RUN_ID |

The last stage (Stage #9) of this sample pipeline uses a Flattener pipeline component 590, to re-combine the original JOB UDR attributes and the attributes of its set of extensions (topics based on ids, dates, SLA, pad, workload) child UDRs to form a resultant or “flattened” UDR of a new composite type. The XML definition for this pipeline component is as follows:

```
<!-- JOB STAGE 9 - flatten enriched job and deliver as BCP -->
    <mule-descriptor name=“jobFlattener”
    implementation=“adapter.grid.job.flattener”>
        <inbound-router>
            <endpoint address=“vm://job_stage_9.queue”/>
        </inbound-router>
        <outbound-router>
            <router className=“org.mule.routing.outbound.
            OutboundPassThroughRouter”>
                <global-endpoint name=“udrBCPEndpoint”/>
            </router>
        </outbound-router>
```

Once the Flattener pipeline component has completed its work, the final UDR is passed to another process (outside the pipeline) which does a bulk copy of the data for insertion into the data warehouse relational database (see 140 of FIG. 1).

This pipeline example defines the end-to-end processing of JOB UDR files. The pipeline results in an enhanced UDR 595 that can be inserted into the database for reporting on the processed and enriched data regarding JOBs running in a compute grid.

In one embodiment, pipelines are configured or “constructed” using specific XML configuration files. The files define how a pipeline is structured and which components are used and in what order they will process UDR data to implement specific business logic. The XML files is one embodiment by which pipelines are defined and configured without having to actually modify the source code for the pipeline component or framework in order to implement new business logic.

The following is a generic example of XML defining two consecutive stages of a pipeline. In this case, stage “X” provides its output to stage “Y”, which in turn provides its output to stage “Z” (the XML template for stage Z is not shown).

```
<!-- JOB STAGE X - functional description -->
    <mule-descriptor name=“componentNameX”
    implementation=“component.ImplementationX”>
        <inbound-router>
            <endpoint address=“vm://job_stage_X.queue”/>
        </inbound-router>
        <outbound-router>
            <router className=“router”>
                <endpoint address=“vm://job_stage_Y.queue”/>
            </router>
        </outbound-router>
    </mule-descriptor>
<!-- JOB STAGE Y - functional description -->
    <mule-descriptor name=“componentNameY”
    implementation=“component.ImplementationY”>
        <inbound-router>
            <endpoint address=“vm://job_stage_Y.queue”/>
        </inbound-router>
        <outbound-router>
            <router className=“router”>
                <endpoint address=“vm://job_stage_Z.queue”/>
            </router>
        </outbound-router>
    </mule-descriptor>
```

This XML defines the pipeline components to be used at these two stages of the pipeline (as defined by “component.ImplementationX” and “component.ImplementationY”) and the inbound and outbound “sockets” by which the input is obtained from the previous pipeline component, and where the resultant output of the current pipeline's computations are sent to the next pipeline component.

It is further contemplated to provide a “GUI-based” interface that provides a graphical representation of each pipeline component which can be configured and positioned within a canvas and interconnect with other pipeline components in a manner that conforms to specific rules for interconnecting these components. The act of interconnecting the graphical components frees the user from needing to track all the details pertaining to the rules for interconnecting components, any dependencies between components and configure the specific behavior of a component to create a functioning pipeline that implements certain business logic. This embodiment provides a much higher level, more abstract, and visual way of defining and constructing pipelines, such that the user won't require the intimate knowledge needed regarding pipeline components properties and behaviors and XML file formats. Once the pipeline is constructed using the GUI, the tool automatically produces a detailed XML file that could be used to configure the appropriate pipelines at run-time.

It is understood that the present invention may have various other embodiments. Furthermore, while the form of the invention herein shown and described constitutes a preferred embodiment of the invention, it is not intended to illustrate all possible forms thereof. It will also be understood that the words used are words of description rather than limitation, and that various changes may be made without departing from the spirit and scope of the invention disclosed. Thus, the scope of the invention should be determined by the appended claims and their legal equivalents, rather than solely by the examples given.

We claim:

1. A method of processing data comprising the steps of:
a. receiving inputted data from a variety of data sources;
b. determining the content of the data;
c. selecting one or more pipelines based on the data content, each pipeline having predefined interchangeable component parts;
d. executing the selected pipelines on at least one server; and
e. processing said data in the executed pipelines to create a result.

2. The method of claim 1, wherein the pipeline has a plurality of predefined interchangeable component parts, and the component parts are selected from the group consisting of:
a. an Identifier configured to add a unique string of characters to said data;
b. an Injector configured to add one or more values to said data wherein each value is associated with a key defined in said data;
c. a Mapper configured to associate said data with an application;
d. a Dater configured to associate a normalized timestamp with said data;
e. a Padder configured to add an attribute to the data, wherein said attribute has a static value;
f. a Splitter configured to cause one or more splits of said data into a plurality of pieces of data, said one or more splits occurring at a specified string;
g. a Time-Slicer configured to cause one or more splits of said data into a plurality of pieces of data, said one or more splits occurring during at least one specified time interval;
h. a Flattener configured to compose a new piece of data based on said inputted data and modifications by another said component part;
i. a Joiner configured to create a piece of data from a combination of said inputted data and at least one second or more set(s) of inputted data;
j. a Correlator configured to provide a means for correlating messages;
k. an Executor which can facilitate the execution of processes external to the selected pipelines during execution of said selected pipelines;
l. a Cartographer configured to dynamically assemble a mapping relationship;
m. an Imbuer configured to perform multiple mappings;
n. a Transcriber configured to copy at least one source attribute to one or more destination attributes;
o. a UDRFanOutWriter configured to distribute UDRs based on start time grid name and collection batch; and
p. a Windower configured to temporally organize information.

3. The method of claim 1, wherein said result is entered into a database or data file.

4. The method of claim 2, wherein said identifier is a 64 bit string and said string is added at the beginning of said data.

5. The method of claim 1, wherein inputted data is disparate data and the result is normalized or enriched data.

6. The method of claim 2, wherein at least said steps of reading, choosing, executing, and processing, are repeated at least once.

7. The method of claim 2, wherein at least said steps of reading, choosing, executing, and processing, are automated.

8. The method of claim 2, wherein said at least a time interval is a plurality of time intervals.

9. The method of claim 8, wherein said plurality of time intervals are regularly-spaced.

10. The method of claim 2, wherein a first component part of said pipeline is a mapper.

11. The method of claim 2, wherein an additional interchangeable component part is provided and said additional interchangeable component part conducts mathematical operations or data transformations.

12. The method of claim 2, further comprising the step of monitoring and controlling said processing.

13. The method of claim 2, wherein said interchangeable component part is modular.

14. The method of claim 2, wherein a pipeline execution sequence is defined in an XML configuration file.

15. The method of claim 1, wherein the pipeline has at least three predefined interchangeable component parts, and the component parts are selected from the group consisting of:
a. an identifier configured to add a unique string of characters to said data;
b. an injector configured to add values to said data wherein said value is associated with a key defined in said data;
c. a mapper configured to associate said data with an application;
d. a dater configured to associate a timestamp with said data;
e. a padder configured to add an attribute to the data, wherein said attribute has a static value;
f. a splitter configured to cause one or more splits of said data into a plurality of pieces of data, said one or more splits occurring at a specified string;
g. a time-splicer configured to cause one or more splits of said data into a plurality of pieces of data, said one or more splits occurring at least a specified time interval;
h. a flattener configured to compose a new piece of data based on said inputted data and modifications by another said component part;
i. a joiner configured to create a piece of data from a combination of said inputted data and a second set of inputted data;
j. a correlator configured to provide a means for correlating messages; and
k. an executor which can facilitate the execution of processes external to the selected pipelines during execution of said selected pipeline.

16. A device comprising:
a. a reader configured to read inputted data;
b. a processing agent configured to determine content of said data and further configured to choose one or more pipelines based on the data content, each pipeline comprising a plurality of predefined interchangeable component parts;
c. a server configured to execute said pipeline; and
d. a processing agent configured to create a result based on said execution of said pipeline.

17. The device of claim 16, wherein the plurality of component parts are selected from the group consisting of:
a. an identifier configured to add a unique string of characters to said data;
b. an injector configured to add values to said data wherein said value is associated with a key defined in said data;
c. a mapper configured to associate said data with an application;
d. a dater configured to associate a timestamp with said data;
e. a padder configured to add an attribute to the data, wherein said attribute has a static value;
f. a splitter configured to cause one or more splits of said data into a plurality of pieces of data, said one or more splits occurring at a specified string;
g. a time-splicer configured to cause one or more splits of said data into a plurality of pieces of data, said one or more splits occurring at least a specified time interval;
h. a flattener configured to compose a new piece of data based on said inputted data and modifications by another said component part;
i. a joiner configured to create a piece of data from a combination of said inputted data and a second set of inputted data;
j. a correlator configured to provide a means for correlating messages;
k. an executor which can facilitate the execution of processes external to the selected pipelines during execution of said selected pipelines;
l. a Cartographer configured to dynamically assemble a mapping relationship;
m. an Imbuer configured to perform multiple mappings;
n. a Transcriber configured to copy at least one source attribute source attribute to one or more destination attributes;
o. a UDRFanOutWriter configured to distribute UDRs based on start time (hourly granularity), grid name and collection batch; and
o. a Windower configured to temporally organize information.

18. The device of claim 17, wherein said result is stored as a data file or entered into a relational database.

19. The device of claim 17, wherein said identifier is a 64 bit string and said string is added at the beginning of said data

20. The device of claim 17, wherein said inputted data is disparate data and said result is normalized data.

21. The device of claim 17, wherein at least said steps of reading, choosing, executing, and processing, are repeated at least once.

22. The device of claim 17, wherein said at least a time interval is a plurality of time intervals.

23. The device of claim 17, wherein said plurality of time intervals are regularly-spaced.

24. The device of claim 17, wherein a first said interchangeable component part of said pipeline is said mapper.

25. The device of claim 17, wherein an additional interchangeable component part is provided and said additional interchangeable component part conducts mathematical operations.

26. The device of claim 17, wherein said interchangeable component part is modular.

27. The device of claim 17, wherein the pipeline has at least three predefined interchangeable component parts, and the component parts are selected from the group consisting of:
a. an identifier configured to add a unique string of characters to said data;
b. an injector configured to add values to said data wherein said value is associated with a key defined in said data;
c. a mapper configured to associate said data with an application;
d. a dater configured to associate a timestamp with said data;
e. a padder configured to add an attribute to the data, wherein said attribute has a static value;
f. a splitter configured to cause one or more splits of said data into a plurality of pieces of data, said one or more splits occurring at a specified string;
g. a time-slicer configured to cause one or more splits of said data into a plurality of pieces of data, said one or more splits occurring at least a specified time interval;
h. a flattener configured to compose a new piece of data based on said inputted data and modifications by another said component part;
i. a joiner configured to create a piece of data from a combination of said inputted data and a second set of inputted data;
j. a processor configured to receive instructions from and carry out such instructions from one or more external component parts;
k. a correlator configured to provide a means for correlating messages; and
l. an executor which can facilitate the execution of processes external to the selected pipelines during execution of said selected pipeline.
